(19) United States
(12) Patent Application Publication
(10) Pub. No.: US 2007/0257463 A1
(43) Pub. Date: Nov. 8, 2007

(54) REVERSIBLE A-ARM FOR GOLF CAR AND OFF-ROAD UTILITY VEHICLES

(76) Inventors: Anthony J. Sanville, Evans, GA (US); William N. Mosuch, Augusta, GA (US)

Correspondence Address: HARNESS, DICKEY & PIERCE, P.L.C., P.O. BOX 828, BLOOMFIELD HILLS, MI, 48303, US

(21) Appl. No.: 11/381,920

(22) Filed: May 5, 2006

(51) Int. Cl. B60G 7/00

(52) U.S. Cl. 280/124.134

(57) ABSTRACT

A golf car includes an independent front suspension system having an identical pair of A-arms reversibly arranged with respect to each other. Each A-arm includes a Y-shaped, channel-configured body having a first end and a second end. A first tube member is connected to the first end. A second tube member is also connected to the first end and is spatially separated from the first tube member. The second tube member is co-axial with the first tube member. A third tube member is connected to the second end of the body. A longitudinal axis extending through the first and second tube members is parallel to a third tube member longitudinal axis. Each of the first and second tube members are connected for co-rotation about the longitudinal axis to a frame structure of the golf car. The third tube member is connected to a wheel structure.

### FIELD

The present teachings relate to devices and methods for manufacturing suspension system components used in golf car and off-road utility vehicles.

### BACKGROUND

Golf cars commonly have rigid or single axle suspension systems for both the front steerable wheels and the rear driving wheels. A solid axle provides a stiffer ride feel for the occupants and can also result in reduced control of the golf car over rough terrain and when turning at higher speeds. Some golf car designs have therefore used an independent suspension system at least for the front steerable wheels which eliminates the solid axle and separately suspends each front steerable wheel from the frame or structure of the golf car.

Drawbacks of existing independent suspension designs for golf cars include the structure of the A-arm assemblies used to independently mount the steerable wheels. Castings have been used in these applications which are expensive to manufacture and are susceptible to cracking or breakage upon receipt of high impact loads which can occur if the golf car strikes a stationary object. An improved A-arm design is therefore desirable for independent suspensions for golf cars as well as other utility vehicles.

### SUMMARY

According to several various embodiments, a suspension system A-arm for a utility vehicle can have a generally Y-shaped, channel-configured body having a first end and a second end. A first and a second extension portion define the first end. A first tube member can be connected to the first extension portion. A second tube member can be connected to the second extension portion, the second tube member being positioned in co-axial alignment with the first tube member. A third tube member can be connected to the second end of the body. A longitudinal axis extending through the first and second tube members is substantially parallel to a third tube member longitudinal axis.

According to other various embodiments, a suspension system A-arm for a golf car can include a generally Y-shaped, channel-configured body having a first end and a second end. A first tube member can be connected to the first end. A second tube member can also be connected to the first end and spatially separated from the first tube member. The second tube member can be positioned in co-axial alignment with the first tube member. A third tube member can be connected to the second end of the body. A plurality of body side walls includes a first side wall extending between the first tube member and the second tube member. A second side wall extends between the first tube member and the third tube member. A third side wall extends between the second tube member and the third tube member.

In still other various embodiments, a golf car includes an independent front suspension system having an identical pair of A-arms reversibly arranged with respect to each other. Each A-arm includes a Y-shaped, channel-configured body having a first end and a second end. A first tube member is connected to the first end. A second tube member is also connected to the first end and is spatially separated from the first tube member. The second tube member is aligned co-axial with the first tube member. A third tube member is connected to the second end of the body. A longitudinal axis extending through the first and second tube members is parallel to a third tube member longitudinal axis. Each of the first and second tube members are connected for co-rotation about the longitudinal axis to a frame structure of the golf car. The third tube member is connected to a wheel structure.

In yet still other various embodiments, a method for creating an A-arm for a utility vehicle such as a golf car or is provided.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having a reversible A-arm suspension system member according to various embodiments;

FIG. 2 is a perspective view of an independent suspension system for the golf car of FIG. 1;

FIG. 3 is a perspective view of an A-arm of the present invention;

FIG. 4 is a top plan view of the A-arm of FIG. 3;

FIG. 5 is a first side elevational view of the A-arm of FIG. 4;

FIG. 6 is a second side elevational view of the A-arm of FIG. 4;

FIG. 7 is a front elevational view of the left handed wheel assembly of FIG. 2 showing the A-arm of the present teachings connected to exemplary suspension members of the suspension system of FIG. 2;

FIG. 8 is a side elevational view taken at view 8-8 of FIG. 7; and

FIG. 9 is plan view taken at view 9-9 of FIG. 7.

### DETAILED DESCRIPTION

The following description is merely exemplary in nature and is in no way intended to limit the present teachings, its application, or uses. Throughout this specification, like reference numerals will refer to like elements.

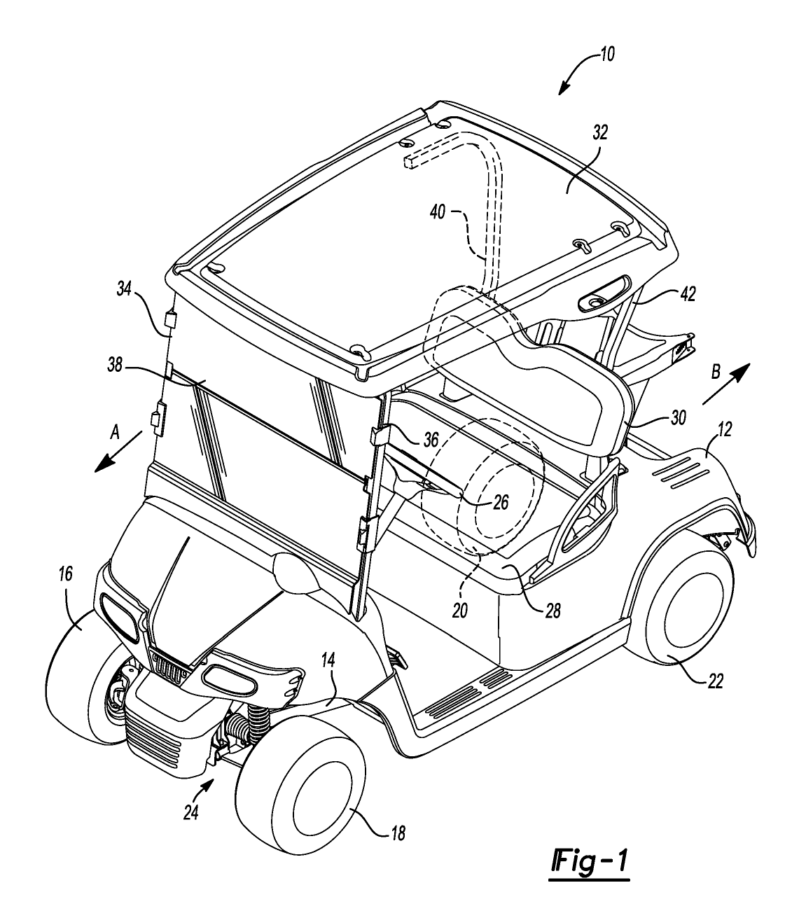

Referring generally to FIG. 1, a golf car 10 includes a body 12 supported from a structural frame 14. Frame 14 can also support a plurality of wheels including a first steerable 16 and a second steerable wheel 18. In addition, powered or driven wheels including a first driven wheel 20 and a second driven wheel 22 are commonly connected to a rear structural portion of frame 14. A suspension system 24 can also be provided which is adapted for steering each of the first and second steerable wheels 16, 18. A steering mechanism 26 which commonly includes a steering wheel and a support post assembly can also be connected to suspension system 24 to provide the necessary steering input to first and second steerable wheels 16,18.

Golf car 10 can also include a passenger bench seat 28 and a passenger back support cushion 30. A cover or roof 32 can also be provided which is supported from either body 12 or frame 14 by first and second support members 34, 36. A windshield or windscreen 38 is also commonly provided which is also supported by each of first and second support members 34, 36. A rear section of roof 32 can be supported by each of a first and a second rear support frame element 40, 42. Other elements which are commonly provided with golf car 10 include golf bag support equipment, accessory racks or bins, and other optional equipment such as environmental covers which are not shown in FIG. 1 for clarity.

Golf car 10 is commonly propelled using an engine or battery/motor system which is commonly provided below bench seat 28. Golf car 10 is capable of motion in either of a forward direction “A” or a rearward direction “B”. Each of first and second steerable wheels 16, 18 can be simultaneously rotated or turned using steering mechanism 26. Each of first and second steerable wheels 16, 18 are also independently supported to frame 14 using suspension system 24. This permits each of first and second steerable wheels 16, 18 to deflect upwardly or downwardly as viewed in FIG. 1 independent of each other.

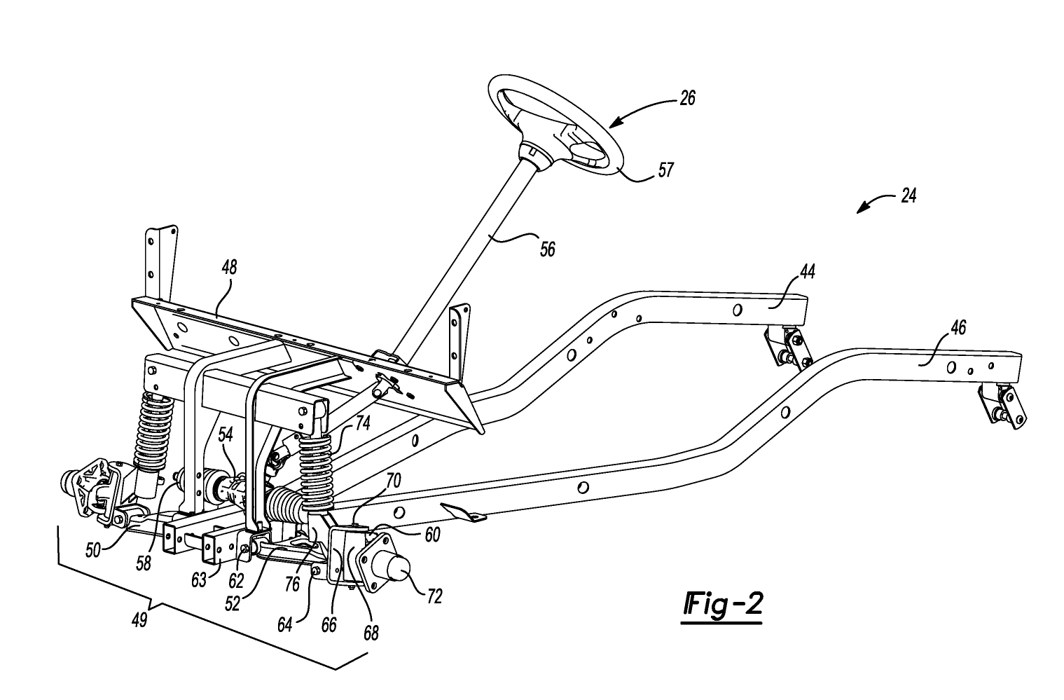

As best seen in reference to FIG. 2, frame 14 can further include a first frame member 44 and a second frame member 46. First and second frame members 44, 46 can be hollow, rectangularly shaped members which are created of a steel material or similar structural material and formed by welding, extruding, hydroforming, or similar processes. A support structure 48 can be connected to and supported by each of first and second frame members 44, 46. Support structure 48, together with first and second frame members 44, 46, support an independent suspension system 49. Independent suspension system 49 supports each of the first and second steerable wheels 16, 18 shown in FIG. 1.

Independent suspension system 49 can include a first A-arm 50 and a second A-arm 52 of the present teachings. Each of first and second A-arms 50, 52 are a pair of identical A-arms which are reversibly disposed to create a right hand and a left hand wheel support assembly. Because each of the right hand and left hand wheel support assemblies are substantially identical, only the left hand wheel assembly having second A-arm 52 will be further discussed herein.

A steering gear 54 coupled to a steering column 56 receives a manual turning force from a steering wheel 57. A bellows 58 protects a further portion of steering mechanism 26 associated with steering gear 54. A steering arm 60 can extend from bellows 58 and connect to a spindle 68. Spindle 68 can be rotatably joined to a wheel support structure or steering knuckle 66 using a knuckle pin 70. Spindle 68 can be rotatably coupled to a wheel hub 72 which allows rotation of second steerable wheel 18. When directed by steering gear 54, steering arm 60 can direct rotation of spindle 68 and thereby turn second steerable wheel 18. In addition to the connection provided to second frame member 46 by second A-arm 52, steering knuckle 66 can be also connected to support structure 48 using a spring/shock absorber assembly 74 which is connected to steering knuckle 66 using a mount arm 76.

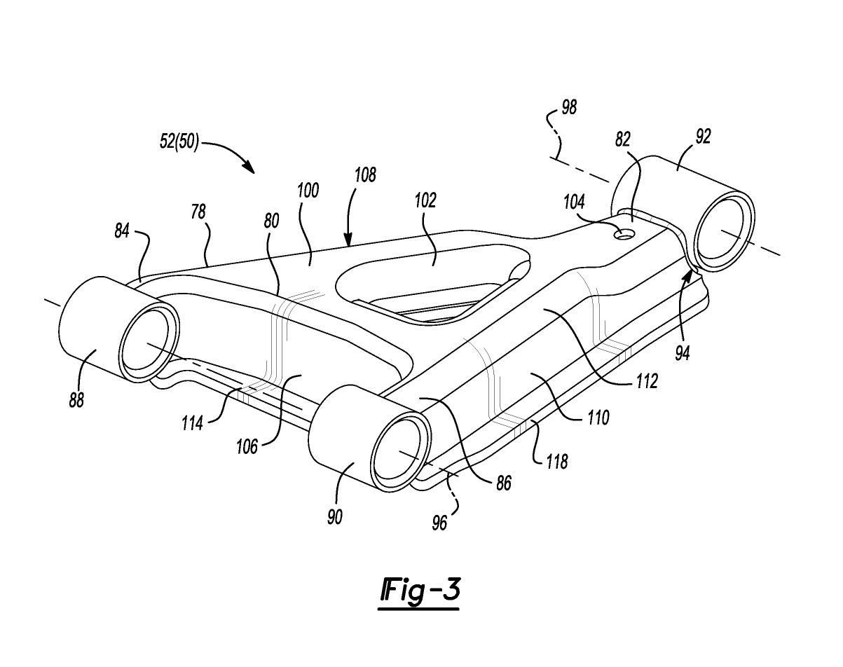

Referring generally now to FIG. 3, a single A-arm assembly is reversible to provide both a first and a second A-arm 50 and 52. Each A-arm 50, 52 can include a channel body 78 having a first end 80 and a second end 82. First end 80 can further include a first extension portion 84 and a second extension portion 86. A first tube 88 can be connected to first extension portion 84 and a second tube 90 can be connected to second extension portion 86. A third tube 92 can be connected to second end 82. Each of the first, second, and third tubes 88, 90, 92 can be connected to channel body 78 for example using a welded joint such as a fillet weld. The first, second and third tubes 88, 90, 92 are thereby fixedly connected to channel body 78. A first longitudinal axis 96 is defined through each of first and second tubes 88, 90 such that first and second tubes 88, 90 are co-axially aligned on first longitudinal axis 96. First, second, and third tubes 88, 90 and 92 can be created from a metal such as steel, and in several embodiments are created from tubing made of 1018 or 1020 cold rolled steel which can also be used for body 78.

A second longitudinal axis 98 can be disposed through third tube 92. Second longitudinal axis 98 is oriented substantially parallel to first longitudinal axis 96. Channel body 78 can further include a main plate section 100 which includes a weight reduction aperture 102 and a drain aperture 104. A plurality of side walls can extend away from main plate section 100. The side walls can include a first side wall 106 extending between first and second tubes 88, 90, a second side wall 108 extending between first tube 88 and third tube 92, and a third side wall 110 extending between second tube 90 and third tube 92. Additional or fewer side walls can also be used in the various embodiments. Each of the first, second and third side walls 106, 108, 110 can further include a rounded corner 112 at the junction between the side wall and the main plate section 100.

Each of the side walls can include a lip or flange which extends from a distal end of the side wall and which can be oriented substantially perpendicular to the side wall. These flanges can include a first flange 114 extending from first side wall 106, a second flange 116 (not visible in FIG. 3) extending from second side wall 108, and a third flange 118 extending from third side wall 110. Each of the first, second and third flanges 114, 116, 118 define a common plane.

Weight reduction aperture 102 can be substantially triangular shaped in several various embodiments can include inner walls extending for a substantial inner perimeter of weight reduction aperture 102. Drain aperture 104 is provided for the application when the first, second, and third flanges 114, 116, 118 are directed upwards with respect to main plate section 100. This application can create an inner cavity which collects moisture which is therefore drained using drain aperture 104. Drain aperture 104 can also function as a centering aperture when used in conjunction with a fixture to hold main plate section 100 during welding of tube members 88, 90, 92.

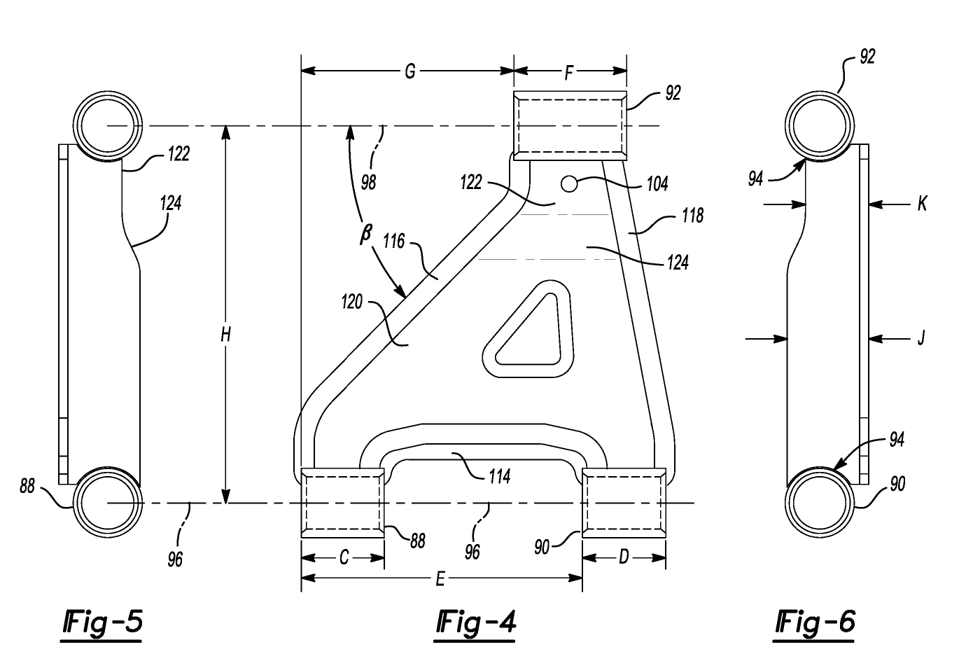

As best seen now in reference to FIGS. 4 through 6, each A-arm 50, 52 can further include a first plate section 120 of main plate section 100 having weight reduction aperture 102 disposed therein. A second plate section 122 can be disposed proximate to second end 82. A depth transition section 124 can be provided to transition between first plate section 120 and second plate section 122.

As best seen in further reference to FIG. 4, first tube 88 has a length “C” and second tube 90 has a length “D”. In several embodiments, length “C” and length “D” are substantially equal. Second tube 90 is positioned with respect to first tube 88 by a tube spacing dimension “E”. In some embodiments of the present teachings, tube spacing dimension “E” is approximately 138.2 mm. Third tube 92 has a third tube length “F” which in several embodiments is greater than both first and second tube lengths “C” and “D”. Third tube 92 is spatially separated from first tube 88 by a third tube positioning dimension “G”. In several embodiments, third tube positioning dimension “G” is approximately 108 mm. First longitudinal axis 96 is spaced from second longitudinal axis 98 by an axis spacing dimension “H”, which in several embodiments is approximately 190.8 mm. First plate section 120 is spaced from any of the first, second and third flanges 114, 116, 118 by a first depth dimension “J”, which in several embodiments is greater than a second depth “K” measurable between second plate section 122 and the various flanges 114, 116, 118.

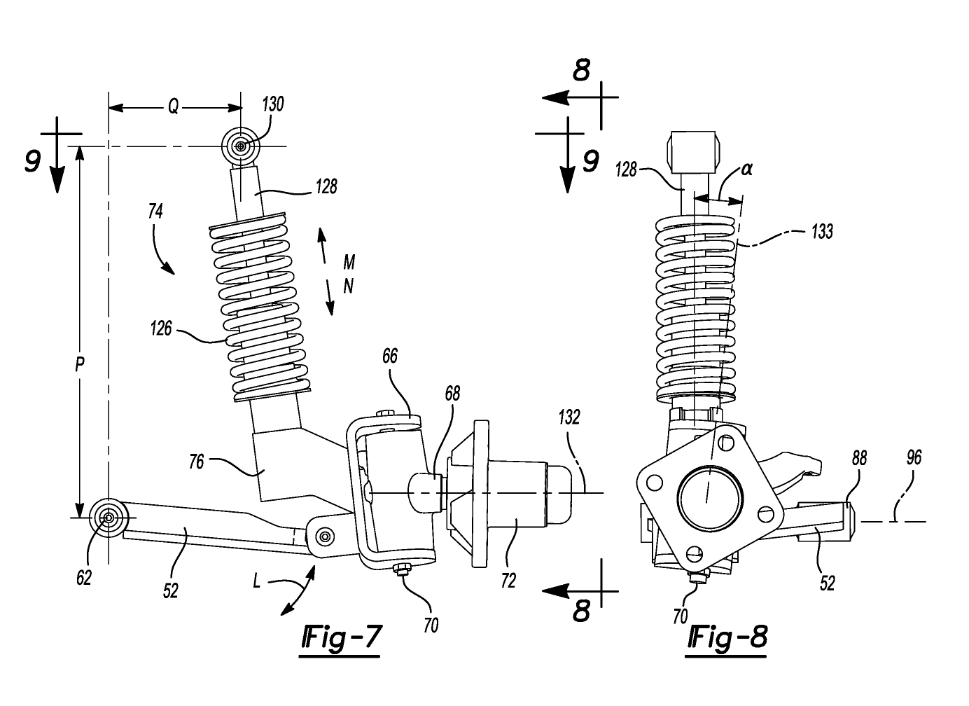

Referring generally now to FIG. 7, details of the left handed wheel support assembly are shown. Second A-arm 52 is rotatably supported by pin 62 to permit steering knuckle 66 and wheel hub 72 to rotate about wheel deflection arc “L”. A coil spring 126 and a shock absorber 128 of spring/shock absorber assembly 74 deflect to allow motion of spring/shock absorber assembly 74 in each of a compression direction “M” and an expansion direction “N”. Shock absorber 128 can be fixedly connected at a mounting pin 130 to support structure 48. A predetermined vertical distance “P” which in several embodiments of the present teachings is substantially equal to 332.7 mm, and a predetermined horizontal distance “Q” which in some embodiments is substantially equal to 114.5 mm provide the fixed points of reference for rotation of second A-arm 52 with respect to pin(s) 62 and mounting pin 130. Second steerable wheel 18 is rotatably mounted on wheel hub 72 along a hub rotation axis 132.

As best seen in reference to FIG. 8, a nominal angle α is defined between a longitudinal axis of shock absorber 128 and a knuckle pin axis 133. In several embodiments, angle α is approximately 38°.

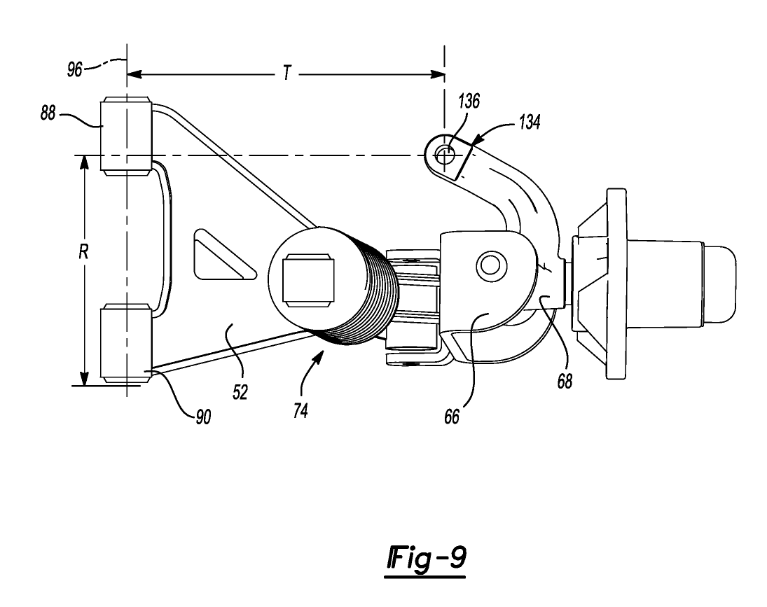

Referring now to FIG. 9, steering arm 134 can be fixedly coupled to spindle 68 for rotation of spindle 68 in response to the force imparted from steering arm 60 when steering wheel 57 is rotated. Steering arm 60 can be rotatably connected to steering arm 134 using a pin centrally positioned within a pin aperture 136 of steering arm 134. A separation distance “R” is provided from an exterior or outward facing end of second tube 90 and the center axis of pin aperture 136. The center axis of pin aperture 136 is also spaced from first longitudinal axis 96 by a spacing dimension “T”. In various embodiments separation distance “R” is approximately 148.7 mm and separation distance “T” is approximately 211 mm.

First and second A-arms 50, 52 of the present teachings can be created using a stamping or a drawing process which also creates the first, second and third side walls 106, 108, 110. This construction creates A-arms 50, 52 in channel-like configurations which are generally at least as strong as cast A-arm assemblies, however, A-arms of the present teachings are lighter and less expensive than their cast counter-parts. Also, by using tubing for the bearing sleeves or first, second and third tubes 88, 90, 92, no further machining of the bores of these tubes is required, which is commonly required for the integrally cast bores when cast parts are used in these applications. Co-axial alignment of first and second tubes 88, 90 as well as alignment of first and second tubes 88, 90 to third tube 92 can be maintained by welding these tubes in a fixture. This simplifies construction of the A-arms of the present teachings. The use of extended flanges from each of the walls of the A-arms of the present teachings further stiffens the A-arms.

The body 78 and the first, second, and third tubes 88, 90, 92, when collectively held in a fixture or jig prior to welding or connecting the tubes, promotes grinding or finishing to prepare the body or to complete the welds. The use of a fixture as noted above also establishes and maintains the coaxial alignment of the first and second tubes 88, 90, and maintains the parallel alignment of the second longitudinal axis 98 of the third tube 92 with respect to the first longitudinal axis 96 of the first and second tubes 88, 90, both before and during the welding process. Weld joints such as fillet welds can be used to connect the tubes to the body 78, however the present teachings are not limited to a specific type of weld joint, or to the use of any specific weld process. Other processes such as brazing are also within the scope of the present teachings.

The body depths “J” and “K” and a rounded or curving geometry of side walls 108, 110 (as best seen in FIGS. 4 and 6) where these walls connect to the tubes are predetermined so an impact load received from a front collision with an object at one of the first or second steerable wheels 16 or 18 can be absorbed. The impact load is received through third tube 92 and is substantially transferred to first tube 88 by side wall 108. Referring again to FIG. 4, an included angle β ranging between approximately 40 to 60 degrees, and in some embodiments being approximately 45 degrees, defined between a substantially straight portion of side wall 108 and second longitudinal axis 98, is also predetermined to maximize impact load transfer. The body depths “J” and “K”, the included angle β, and the curving geometry of side walls 108, 110 proximate to the tube connections combine to increase the load carrying capability before yield of either first or second A-arm 50, 52. The use of tubing for first, second and third tubes 88, 90 and 92 which is welded or otherwise fixedly connected to first and second A-arms 50, 52 also increases the impact load which can be absorbed compared to known A-arm assemblies which have end plates rolled over or stamped to form connection tubes. Common A-arm designs are often not designed to absorb this type of impact load without yielding the material of the A-arm.

The description of the teachings is merely exemplary in nature and, thus, variations that do not depart from the gist of the invention are intended to be within the scope of the disclosure. For example, A-arms of the present teachings are described herein with respect to use in a golf car suspension, however, the present teachings are not limited to A-arms for suspension systems of golf cars and can be used in other vehicles such as off-road vehicles, all terrain vehicles, and the like. These other vehicles can include food/beverage carts, golf course maintenance vehicles, hunting/sport activity vehicles, and the like. Such variations are not to be regarded as a departure from the spirit and scope of the present disclosure.

What is claimed is:

1. A suspension system A-arm for a utility vehicle, comprising:
a generally Y-shaped, channel-configured body having a first end and a second end;
a first and a second extension portion defining the first end;
a first tube member connected to the first extension portion;
a second tube member connected to the second extension portion, the second tube member positioned in co-axial alignment with the first tube member; and
a third tube member connected to the second end of the body;
wherein a longitudinal axis extending through the first and second tube members is substantially parallel to a third tube member longitudinal axis.

2. The A-arm according to claim 1, wherein each of the first and second tube members comprise an equal first length.

3. The A-arm according to claim 2, wherein the third tube member comprises a second length greater than the first length of the first and second tube members.

4. The A-arm according to claim 1, wherein the first and second extension portions are joined by a body portion having a first depth and a weight reduction aperture.

5. The A-arm according to claim 4, further comprising a second body portion proximate to the third tube member, the second body portion having a depth less than the first depth.

6. The A-arm according to claim 5, wherein each of the body portion and the second body portion include an outwardly extending flange.

7. The A-arm according to claim 5, further comprising:
a depth transition portion connecting the first and second body portions; and
a drain aperture positioned in the second body portion.

8. The A-arm according to claim 1, further comprising:
a first side wall of the body having a substantially straight central portion transitioning into a curving portion proximate each of the first and third tube members; and
a predetermined angle ranging between approximately 40 to approximately 60 degrees defined between the straight central portion and a longitudinal axis of the third tube member;
wherein a depth of the first side wall is predetermined to direct an impact load received at the third tube member to the first tube member through the first side wall without yielding the A-arm.

9. The A-arm according to claim 8, further comprising a second side wall of the body having a substantially straight middle portion transitioning into a curving portion proximate each of the second and third tube members.

10. The A-arm according to claim 1, further comprising a weld joint connecting individual ones of the first, second, and third tube members to the body.

11. The A-arm according to claim 1, wherein each of the body and the first, second, and third tube members comprise a cold rolled 1018 or 1020 steel.

12. A suspension system A-arm for a golf car, comprising:
a generally Y-shaped, channel-configured body having a first end and a second end;
a first tube member connected to the first end;
a second tube member connected to the first end and spatially separated from the first tube member, the second tube member positioned in co-axial alignment with the first tube member;
a third tube member connected to the second end of the body; and
a plurality of body side walls including:
a first side wall extending between the first tube member and the second tube member;
a second side wall extending between the first tube member and the third tube member; and
a third side wall extending between the second tube member and the third tube member.

13. The A-arm of claim 12, wherein each of the first, second, and third side walls further comprise an outwardly extending flange.

14. The A-arm of claim 13, wherein each flange is configured substantially perpendicular to the corresponding side wall.

15. The A-arm of claim 12, wherein the body further comprises a plate section connecting the first, second and third side walls.

16. The A-arm of claim 15, wherein the plate section further comprises:
a first section having a first depth, the first section located proximate to the first and second tube members; and
a second section having a second depth less than the first depth, the second section proximate to the third tube member
wherein the first and second depths are predetermined to direct an impact load received at the third tube member to the first tube member through the first side wall without yielding the A-arm.

17. The A-arm of claim 12, wherein the first end further comprises:
a first extension portion; and
a second extension portion;
wherein the first tube member is connected to the first extension portion and the second tube member is connected to the second extension portion.

18. The A-arm of claim 12, wherein a longitudinal axis extending through the first and second tube members is substantially parallel to a third tube member longitudinal axis.

19. The A-arm of claim 12, further comprising at least one weld joint connecting individual ones of the first, second, and third tube members to the body.

20. A golf car, comprising:
an independent front suspension system having at least one A-arm, the A-arm including:
a generally Y-shaped, channel-configured body having a first end and a second end;
a first tube member connected to the first end;
a second tube member connected to the first end and spatially separated from the first tube member, the second tube member positioned in co-axial alignment with the first tube member; and
a third tube member connected to the second end of the body;
a longitudinal axis extending through the first and second tube members being substantially parallel to a third tube member longitudinal axis; and
wherein each of the first and second tube members are connected for co-rotation about the longitudinal axis to a frame structure of the utility vehicle, and the third tube member is connected to a wheel support structure of the utility vehicle.

21. The golf car of claim 20, wherein the at least one A-arm comprises an identical pair of A-arms reversibly oriented with respect to each other.

22. The golf car of claim 21, further comprising:
a first steerable wheel connected to the frame structure using a first one of the pair of A-arms; and
a second steerable wheel connected to the frame structure using a second one of the pair of A-arms.

23. The golf car of claim 20, wherein the first end further comprises:
a first extension portion; and
a second extension portion;
wherein the first tube member is welded to the first extension portion and the second tube member is welded to the second extension portion.

24. The golf car of claim 20, wherein the body further comprises:
a plurality of body side walls including:
a first side wall extending between the first tube member and the second tube member;
a second side wall extending between the first tube member and the third tube member; and
a third side wall extending between the second tube member and the third tube member.

25. The golf car of claim 24, wherein each of the first, second, and third side walls further comprise an outwardly extending flange.

26. The golf car of claim 25, wherein each flange is configured substantially perpendicular to the corresponding side wall.

27. The golf car of claim 24, wherein the body further comprises a plate section connecting the first, second and third side walls.

28. The golf car of claim 27, wherein the plate section further comprises:
a first section having a first depth, the first section located proximate to the first and second tube members; and
a second section having a second depth less than the first depth, the second section proximate to the third tube member.

29. The golf car of claim 20, wherein each of the first and second tube members comprise an equal first length.

30. The golf car of claim 29, wherein the third tube member comprises a second length greater than the first length of the first and second tube members.

31. A method for creating an A-arm for a utility vehicle, the A-arm having a body including a main plate section and a plurality of walls each extending perpendicularly from the main plate section, and first and second body ends, the method comprising:
forming the A-arm body using one of a stamping and a drawing process;
bending distal ends of the plurality of walls to define a plurality of flanges; and
welding individual ones of three tube members to one of the first end and the second end of the body.

32. The method of claim 31, further comprising coaxially aligning the first and second tube members on a common longitudinal axis proximate the first end.

33. The method of claim 32, further comprising aligning an axis of the third tube member substantially in parallel with the longitudinal axis of the first and second tube members.

34. The method of claim 33, further comprising mounting the tube members and the body in a fixture to retain alignment of the tube members relative to each other prior to the welding step.

35. The method of claim 31, further comprising creating first and second extensions of the first end, the first extension operably receiving the first tube member and the second extension operably receiving the second tube member.

36. The method of claim 31, further comprising orienting the flanges substantially perpendicular to the walls and parallel to the main plate section.
